(19) United States
(12) Patent Application Publication
(10) Pub. No.: US 2011/0214803 A1
(43) Pub. Date: Sep. 8, 2011

(54) VACUUM THERMOFORMING OF THERMOPLASTIC SHEETS WITH DECORATIVE INSERTS

(75) Inventors: Frederick J. Homburg, JR., Woodhaven, MI (US); Christophe Baillet, West Bloomfield, MI (US)

(73) Assignee: FAURECIA INTERIOR SYSTEMS, INC., Auburn Hills, MI (US)

(21) Appl. No.: 12/717,370

(22) Filed: Mar. 4, 2010

(51) Int. Cl. B44C 3/02; B29C 65/00; B28B 21/40

(52) U.S. Cl. 156/219; 156/285; 425/504

(57) ABSTRACT

A method of vacuum thermoforming a thermoplastic sheet together with a decorative insert. The decorative insert is placed on a first portion of a surface of a mold tool. The insert is retained in place by applying a localized vacuum to the insert via a plurality of passages through the first portion of the mold tool. The thermoplastic sheet can then be placed over the insert and over the remaining surface of the mold tool. The thermoplastic sheet is then drawn against the mold surface and over the decorative insert by applying a vacuum at a second portion of the surface. The mold surface can be grained or otherwise textured and this texture can extend continuously across the transition between the first and second portions. This permits use of the mold tool to apply a continuous textured surface when used to mold the thermoplastic sheet without the decorative insert.

### TECHNICAL FIELD

The present invention relates generally to vacuum thermoforming processes, and more particularly to keeping decorative inserts in place during vacuum thermoforming processes.

### BACKGROUND OF THE INVENTION

Some vehicle interior panels, such as door panels, dashboard panels, and headliner panels, have decorative inserts of a different material, shape, color, texture, and/or the like than a primary body of the vehicle panel. Vacuum thermoforming is one known way to manufacture these vehicle panels. In vacuum thermoforming processes typically used in the automotive industry for molding in a decorative insert, a surface of a mold tool is provided with a recess that is used to establish and maintain the position of the insert during the process. And when a decorative insert is not needed for a vehicle panel, a filler is often put in the recess in place of the insert so that the same mold tool can be used. The filler and the surface of the mold tool can be designed to impart a textured surface to the primary body of the vehicle panel. But a gap could exist between the filler and the surface because of the recess. And in some cases the gap prevents a corresponding area of the primary body from being continuously textured, leaving a so-called witness line which can be undesirable in many applications.

### SUMMARY OF THE INVENTION

In accordance with one aspect of the invention, there is provided a method of vacuum thermoforming a thermoplastic sheet having a decorative insert. The method includes the steps of placing the decorative insert on a first portion of a surface of a mold tool, retaining the decorative insert at the first portion of the surface by applying a localized vacuum at the first portion, placing the thermoplastic sheet over the decorative insert and over the surface of the mold tool, and drawing the thermoplastic sheet onto the surface and onto the decorative insert by applying a primary vacuum to at least a second portion of the surface of the mold tool.

Another aspect of the invention is directed to a method of retaining a decorative insert to a mold tool. The method includes the steps of placing a decorative insert and a spacer at a portion of a surface of the mold tool, wherein the spacer is located between the portion of the surface and the decorative insert. The spacer makes direct contact with the portion of the surface, and prevents direct contact between the portion and the decorative insert. The method further includes retaining the decorative insert at the portion of the surface by applying a localized vacuum by way of multiple local passages that extend to the surface at the portion.

Another aspect of the invention is directed to a vacuum thermoforming mold including a mold tool and one or more vacuum sources. The mold tool has a surface including a first portion and a second portion. The vacuum source generates a localized vacuum at the first portion by way of a first vacuum line and by way of multiple local passages. The local passages extend through the mold tool to the surface and are located at the first portion. The vacuum source also generates a primary vacuum at the second portion by way of a second vacuum line and by way of multiple primary passages. The primary passages also extend through the mold tool to the surface and are located at the second portion.

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 depicts an exemplary embodiment of a vacuum thermoforming machine and a localized vacuum assembly; and

FIG. 2 is an enlarged, fragmentary view of the mold tool of FIG. 1 showing further details of the localized vacuum assembly and decorative insert.

### DETAILED DESCRIPTION OF THE PREFERRED EMBODIMENT(S)

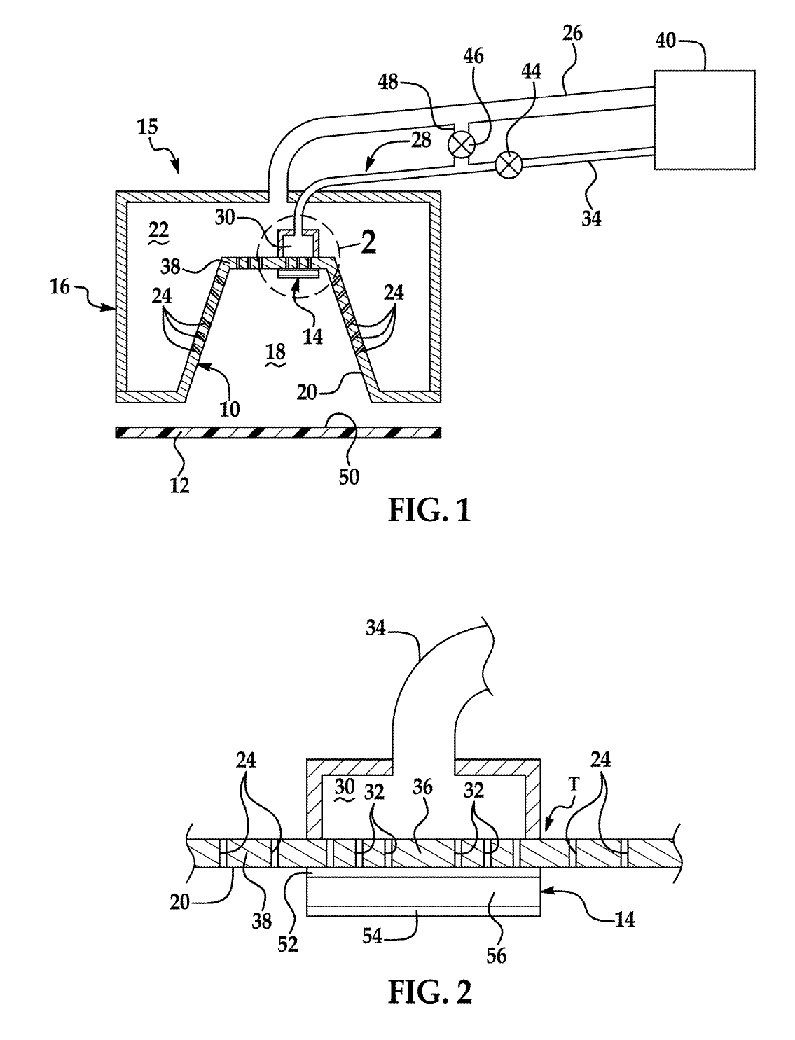

Referring to the drawings, FIGS. 1 and 2 show an exemplary embodiment of a mold tool 10 that can be used both for female vacuum thermoforming a thermoplastic sheet 12 with a decorative insert 14, and for vacuum thermoforming a thermoplastic sheet without a decorative insert. The materials, temperatures, and other general operating conditions used for conventional vacuum thermoforming processes are known to those skilled in the art, and can be used with the process steps described herein. Such vacuum thermoforming processes are commonly used in the manufacture of vehicle interior panels such as door panels, dashboard panels, and headliner panels for cars, trucks, boats, and the like.

In accordance with the illustrated embodiment, the mold tool 10 holds the decorative insert 14 in place by way of a localized vacuum applied to a surface of the mold tool. Here, a recess or pocket in the surface of the mold tool is not needed in order to keep the decorative insert 14 in place. So in a process without a decorative insert, the surface of the mold tool 10 remains continuous without gaps caused by a recess-and-filler technique. The resulting workpiece or thermoplastic sheet 12 has a textured surface without unsightly witness lines.

Referring to FIG. 1, a vacuum thermoforming machine 15 is used in the manufacture of the preformed thermoplastic sheet 12. The vacuum thermoforming machine 15 includes a mold 16 having the mold tool 10 which, in the example of FIG. 1, is shaped with a female cavity 18; other examples could include a male mold tool. The mold tool 10 and back chamber of the mold 16 together can be a one-piece structure, or they can be separate components of the mold 16. The mold tool 10 has a surface 20 which gives the overall shape and contour to the preformed thermoplastic sheet 12. The surface 20 can be designed and constructed to impart a textured or grain-like appearance to the surface of the preformed thermoplastic sheet 12, which in some cases mimics leather, wood, and other materials, or furnishes surface qualities like softness, matte, and the like. The mold 16 includes a primary chamber 22 located beneath or behind the mold tool 10 (beneath or behind meaning an opposite side of the tool 10 than the side having the surface which imparts texturing or graining, though shown actually above in FIG. 1) and communicating with the surface 20 by way of multiple primary passages 24, each of which extends between the primary chamber and the surface. A second or primary vacuum line 26 communicates with the primary chamber 22 and leads to a vacuum source. In the orientation of FIG. 1, the female cavity 18 is shown opened in a vertically downward direction; however, the cavity can be oriented in any suitable direction.

The vacuum thermoforming machine 15 further includes a localized vacuum assembly 28 used to apply the localized vacuum at the surface 20 of the mold tool 10. The localized vacuum can, but need not be applied separately and distinctly from the vacuum applied via the primary vacuum line 26 and chamber 22. A local chamber 30 is located within and isolated from the primary chamber 22, and is located directly beneath or behind the surface 20 where the decorative insert 14 is positioned (beneath or behind meaning an opposite side of the surface 20 than the side of the surface designed to impart texturing or graining). The local chamber 30 communicates with the surface 20 by way of multiple local passages 32, each of which extends between the local chamber and the surface. Each of the local passages 32 can be sized similar to a single primary passage 24, or they can be made larger or smaller, or spaced or distributed in any suitable manner. A first or local vacuum line 34 communicates with the local chamber 30 and leads to a vacuum source that is described below.

Referring to FIG. 2, the localized vacuum is applied only at a first portion 36 of the surface 20, and is not applied at a second portion 38 of the surface which instead is subjected to a primary vacuum applied via the primary chamber 22 and the primary passages 24. The first and second portions 36, 38 are part of the one-piece and unitary surface 20, and are both constructed and designed to impart a textured or grain-like appearance to the surface of a workpiece directly contacting the portions. The first portion 36 does not have a recess or pocket that is otherwise used to keep the decorative insert 14 in place. In other words, a transition region T between the first and second portions 36, 38 is substantially continuous and uninterrupted such that the transition is imperceptible from the conformation of the surface. Of course, this does not mean that the surface 20 does not have designed-in recesses, voids, and/or structures for other purposes such as forming an opening for window controls; it only means that a recess or pocket used to establish the position of a decorative insert where it might cause a witness line is not provided in the surface. The first portion 36 can be defined by the periphery of the local chamber 30, the locations of the local passages 32, and the periphery of the decorative insert 14, or a combination thereof. The second portion 38 comprises the remaining portion of the surface 20 or a majority of the remaining portion; of course, other portions of the surface can exist which are not subject to the localized or primary vacuums.

A vacuum source 40 generates the suction of the localized and primary vacuums. In one embodiment, the vacuum source 40 includes a vacuum pump and a vacuum tank, and in another embodiment, the vacuum source includes only a vacuum pump. In the example of FIG. 1, the vacuum source 40 is a single and common vacuum source for both the localized and primary vacuums, and thus communicates with both the primary vacuum line 26 and the local vacuum line 34. A first valve 44 is located in the local vacuum line 34 and regulates suction thereat by preventing and permitting suction, depending on the stage of the vacuum thermoforming process. A second valve 46 is located in a bridging line 48 which connects and communicates the local vacuum line 34 and the primary vacuum line 26. The second valve 46 regulates suction between the primary and local vacuum lines.

In other examples, the configuration of the vacuum source(s), vacuum lines, and valves can be different than what is shown in FIG. 1. In one example, a single vacuum source could communicate with a single branching vacuum line. Branching can be done in any suitable manner (e.g., using a Y-shaped divergence) to connect the vacuum source in fluidic communication with a primary vacuum line and a local vacuum line. A single three-way valve could be located at the divergence point and could regulate suction between the primary and local vacuum lines, or a two-way valve could be located in each of the primary and local vacuum line. In another example, each vacuum line could have its own vacuum source. A primary vacuum source could communicate with the primary vacuum line, and a separate and independently controlled local vacuum source could communicate with the local vacuum line.

The thermoplastic sheet 12, also known as a skin, conforms to the contour and shape of the mold tool 10 during the vacuum thermoforming process. Once shaped, the thermoplastic sheet 12 is preformed and has an outer or show surface 50 which is textured due to vacuum-assisted contact with the surface 20. The thermoplastic sheet 12 can be composed of a thermoplastic material such as polypropylene, polyethylene, acrylonitrile-butadiene-styrene (ABS), or another suitable material.

The decorative insert 14 is attached (molded) to the thermoplastic sheet 12 during the vacuum thermoforming process. The decorative insert 14 can be of a different material, shape, color, texture, and/or the like as compared to the thermoplastic sheet 12. In some embodiments, the decorative insert 14 is a metal piece, a composite piece, a wood piece, a leather piece, or a fabric piece. Referring to FIG. 2, the decorative insert 14 can include a spacer 52 and an adhesive layer 54. The spacer 52 is a temporary or throw-away preattached piece which makes direct contact with the surface 20 while preventing direct contact between a body 56 of the decorative insert 14 and the surface. The spacer can be impermeable to air such that the vacuum suction acts on the spacer and not through it to the insert. In this approach, the body 56 thus remains untextured during the thermoforming process. The adhesive layer 54 facilitates attachment between the decorative insert 14 and the thermoplastic sheet 12. The adhesive layer 54 can be a preattached sheet or can be an adhesive material applied to the body 56. In other examples, the spacer 52 need not be provided whereby the body 56 then directly contacts the surface 20. And the adhesive layer 54 need not be provided whereby another technique, such as barbs, is used to attach the decorative insert 14 to the thermoplastic sheet 12.

In a vacuum thermoforming process which uses the decorative insert 14, the decorative insert is placed on the surface 20 at the first portion 36. The decorative insert 14 can be placed at the first portion 36 manually by an operator, automatically by robotic equipment, or by other manual and automated ways. The localized vacuum is then initiated to keep and retain the position of the decorative insert 14. Subsequently or simultaneously, the thermoplastic sheet 12 is held by one or more fixtures, and is brought to its increased forming temperature. The thermoplastic sheet 12 is placed over the mold tool 10 and over the decorative insert 14. As shown in FIG. 1, when placed over, the thermoplastic sheet 12 is distanced away from the surface 20 and from the decorative insert 14, or the thermoplastic sheet could contact the surface, the decorative insert, or both. A corresponding and complementary mold half (not shown) of the vacuum thermoforming machine 15 can be closed with the mold 16.

At this point, the localized vacuum is discontinued via the first valve 44, the second valve 46, or both, or is turned off, and the primary vacuum is initiated at the second portion 38. This may be done by first beginning the primary vacuum and thereafter discontinuing the localized vacuum. The primary vacuum draws the moldable thermoplastic sheet 12 onto the surface 20 and over the decorative insert 14. The thermoplastic sheet 12 stretches and is suctioned into direct contact with the surface 20 at the second portion 38 and with the decorative insert 14, and conforms to the shape of the surface and around the decorative insert. The thermoplastic sheet 12 is cooled or allowed to harden with the decorative insert 14 attached thereto to produce the preformed assembly. The preform can then be removed, trimmed, backed with foam, or subsequently processed in another way.

In a vacuum thermoforming process which does not use a decorative insert, the thermoplastic sheet 12 is held, brought to its forming temperature, and placed over the mold tool 10. The vacuum thermoforming machine 15 is closed, and localized and primary vacuums are initiated to draw the moldable thermoplastic sheet 12 onto the surface 20 and into direct contact with the first and second portions 36, 38. The surfaces of the first and second portions 36, 38 give a continuous and uninterrupted textured or grain-like appearance to the show surface 50 of the preformed thermoplastic sheet 12 without witness lines.

In different examples, the vacuum thermoforming process need not be performed in the order described, may differ in one or more particular steps, may have additional steps than those shown and described, and may not necessarily include every step that is shown and described. For example, as noted above the localized vacuum can remain on for a specified time period when the primary vacuum is turned on during the vacuum thermoforming process with the decorative insert. And, during the vacuum thermoforming process without a decorative insert, the localized vacuum need not be initiated whereby only the primary vacuum is initiated.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of vacuum thermoforming a thermoplastic sheet having a decorative insert, the method comprising the steps of:
placing the decorative insert on a first portion of a surface of a mold tool;
retaining the decorative insert at the first portion of the surface by applying a localized vacuum at the first portion;
placing the thermoplastic sheet over the decorative insert and over the surface of the mold tool; and
drawing the thermoplastic sheet onto the surface and onto the decorative insert by applying a primary vacuum to at least a second portion of the surface of the mold tool.

2. The method of claim 1, wherein the first portion of the surface of the mold tool comprises a non-recessed, continuous extension of the surface, and wherein the first and second portions together comprise a one-piece mold tool surface.

3. The method of claim 2, wherein the first and second portions of the surface are textured.

4. The method of claim 1, wherein the localized vacuum is applied via a first vacuum line, and wherein the primary vacuum is applied via a second vacuum line.

5. The method of claim 1, wherein the primary vacuum is applied via a primary chamber and the localized vacuum is applied via a local chamber that is located within the primary chamber and that communicates with the first portion of the surface by way of a plurality of local passages.

6. The method of claim 1, wherein the localized vacuum and the primary vacuum are applied via a common vacuum source.

7. The method of claim 1, further comprising the step of discontinuing application of the localized vacuum during the drawing step.

8. The method of claim 7, wherein the step of discontinuing application of the localized vacuum is performed via at least one valve located in a vacuum line.

9. The method of claim 1, wherein the decorative insert includes a spacer located between a surface of the decorative insert and the first portion of the surface of the mold tool, the spacer preventing direct contact between the surface of the decorative insert and the surface of the mold tool.

10. A method of retaining a decorative insert to a mold tool, the method comprising:
placing the decorative insert and a spacer at a portion of a surface of the mold tool, the spacer being located between the surface portion and the decorative insert and making direct contact with the surface portion and preventing direct contact between the surface portion and the decorative insert; and
retaining the decorative insert at the surface portion of the mold tool by applying a localized vacuum to the spacer via a plurality of local passages located in the surface portion.

11. The method of claim 10, wherein the surface portion is textured.

12. The method of claim 10, wherein the surface portion comprises a non-recessed, continuous extension of the surface.

13. The method of claim 10, wherein the localized vacuum is applied via a local chamber communicating with the local passages and located on a side of the mold tool opposite the spacer and the decorative insert.

14. A vacuum thermoforming mold, comprising:
a mold tool having a surface that includes a first portion and a second portion; and
at least one vacuum source generating a localized vacuum at the first portion via a first vacuum line and via a plurality of local passages extending to the surface at the first portion, said at least one vacuum source generating a primary vacuum at the second portion via a second vacuum line and via a plurality of primary passages extending to the surface at the second portion.

15. The vacuum thermoforming mold of claim 14, wherein the first and second portions are textured.

16. The vacuum thermoforming mold of claim 14, wherein the surface is substantially continuous at a transition between the first and second portions such that the transition is imperceptible from the conformation of the surface.

17. The vacuum thermoforming mold of claim 14, further comprising a primary chamber communicating with the primary passages and with the second vacuum line, and comprising a local chamber located within the primary chamber and communicating with the local passages and with the first vacuum line.

18. The vacuum thermoforming mold of claim 14, further comprising at least one valve located in the first vacuum line, in a bridging line communicating the first and second vacuum lines, or in both, the valve regulating suction generated by the vacuum source.
